(19) United States
(12) Patent Application Publication
(10) Pub. No.: US 2026/0030200 A1
(43) Pub. Date: Jan. 29, 2026

(54) NON-TRANSITORY COMPUTER-READABLE RECORDING MEDIUM, MAPPING RESULT VERIFICATION METHOD, AND MAPPING RESULT VERIFICATION APPARATUS

(71) Applicant: Fujitsu Limited, Kawasaki-shi (JP)

(72) Inventor: Toshihiro SHIMIZU, Sagamihara (JP)

(73) Assignee: Fujitsu Limited, Kawasaki-shi (JP)

(21) Appl. No.: 19/263,661

(22) Filed: Jul. 9, 2025

(30) Foreign Application Priority Data
Jul. 25, 2024 (JP) 2024-120421

(51) Int. Cl. G06F 15/82; G06F 9/30

(52) U.S. Cl. CPC G06F 15/825; G06F 9/3001

(57) ABSTRACT

A non-transitory computer-readable recording medium stores therein a mapping result verification program that causes a computer to execute a process including acquiring both of a data flow graph that represents predetermined calculation including a plurality of arithmetic operations and a mapping result obtained by mapping the data flow graph into a CGRA that includes a plurality of arithmetic operation units, and verifying, regarding each of first arithmetic operation units to which the arithmetic operations have been respectively allocated in the mapping result, based on an arithmetic operation result that has been obtained by performing the arithmetic operations, whether or not the mapping result matches the data flow graph.

### CROSS-REFERENCE TO RELATED APPLICATION

This application is based upon and claims the benefit of priority of the prior Japanese Patent Application No. 2024-120421, filed on Jul. 25, 2024, the entire contents of which are incorporated herein by reference.

### FIELD

The embodiments discussed herein are related to a computer-readable recording medium, a mapping result verification method, and a mapping result verification apparatus.

### BACKGROUND

In recent years, as one of data processing devices, a coarse-grained reconfigurable architecture (CGRA) having excellent calculation performance and excellent energy efficiency for data processing has been drawing attention. The CGRA is a technology for a processor in which arithmetic operation elements that are referred to as processing elements (PEs) each having an arithmetic operation unit, a register, and the like are arranged in a two-dimensional array. The CGRA is a reconfigurable architecture in which arithmetic operation content of arithmetic operations performed by PEs and a data transfer path between the PEs can be reconfigured in operation. In some cases, a processor itself in which the Pes are arranged in a two-dimensional array is referred to as a CGRA.

A program executed by using the CGRA is performed as described below. The program to be executed is converted to a data flow graph (DFG) by using a compiler. The DFG includes nodes each of which indicates an arithmetic operation and directed edges each of which indicates data dependent between the arithmetic operations. The directed edge indicates that output data of a transmission source node is used as input data of a transmission destination node. Then, the arithmetic operation content of the arithmetic operation performed by each of the PEs and a routing line of data between the PEs are decided on the basis of the DFG in accordance with the configuration of each of the PEs included in the CGRA. The decision of both of the arithmetic operation content of the arithmetic operations and the routing line of the data between the PEs are referred to as mapping. After that, data is input to the CGRA in which the mapping has been completed, and then, the CGRA performs an arithmetic operation by using the input data.

If this mapping is manually performed, in a case where a large number of PEs are used or the routing lines of the data are complicated, there is a problem that an error may possibly occur, a problem that it takes time due to a complicated process, and the like. Accordingly, a device that is referred to as an automatic mapper that automatically performs mapping on the basis of a predetermined algorithm that has been decided in accordance with the DFG.

However, there may be a case in which a bug is present in the program for the automatic mapper, and in some cases, a mapping result does not match the DFG. In view of this, it is difficult to check that an output result obtained from the automatic mapper is correct at the time of development of the automatic mapper. For example, in the development of the automatic mapper tailored to the characteristics of the target CGRA, constraint with respect to the mapping and an optimization algorithm are studied by manually trying a mapping, but it is difficult to guarantee that the obtained execution result is a correct result. Accordingly, there is a need to verify the accuracy of the mapping result that has been output from the automatic mapper, that is, there is a need to verify that a result of a calculation performed in accordance with the DFG is the same as the execution result indicated in the CGRA.

Moreover, a technology for verifying equivalence of circuits, there is a proposed technology for verifying the logical equivalence of the circuits by comparing, between a reference circuit for a hardware description language and a gate circuit that is used for a net list and that has been subjected to logic synthesis by inputting the hardware description language, data obtained before and after the processing steps of the logic synthesis.
Patent Document 1: Japanese Laid-open Patent Publication No. 2010-257003

### SUMMARY

According to an aspect of an embodiment, a non-transitory computer-readable recording medium stores therein a mapping result verification program that causes a computer to execute a process including acquiring both of a data flow graph that represents predetermined calculation including a plurality of arithmetic operations and a mapping result obtained by mapping the data flow graph into a CGRA that includes a plurality of arithmetic operation units, and verifying, regarding each of first arithmetic operation units to which the arithmetic operations have been respectively allocated in the mapping result, based on an arithmetic operation result that has been obtained by performing the arithmetic operations, whether or not the mapping result matches the data flow graph.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a mapping result verification apparatus;

FIG. 2 is a diagram illustrating one example of a representation method of representing mapping of a PE;

FIG. 3 is a diagram illustrating one example of a DFG and a mapping result;

FIG. 4 is a diagram illustrating the outline of a mapping result verification process;

FIG. 5 is a diagram illustrating one example of a CGRA targeted for the mapping;

FIG. 6 is a diagram illustrating one example of connections between the PEs;

FIG. 7 is a diagram illustrating one example of verification information list;

FIG. 8 is a diagram illustrating one example of the DFG and the mapping result that are used for a detailed explanation for the mapping result verification process;

FIG. 9 is a diagram illustrating a verification information list in which an output of a zeroth cycle has been registered;

FIG. 10 is a diagram illustrating the verification information list in which an output of a first cycle has been registered;

FIG. 11 is a diagram illustrating the verification information list in which an output of a second cycle has been registered;

FIG. 12 is a flowchart illustrating the flow of the mapping result verification process according to a first embodiment;

FIG. 13 is a diagram illustrating one example of the mapping indicated by using a combination of the mapping and an already existing mapping result in some portions;

FIG. 14 is a diagram for explaining an extension of the representation method of representing the mapping;

FIG. 15 is a diagram illustrating one example of a mapping result according to a second embodiment;

FIG. 16 is a diagram illustrating transitions of the verification information lists obtained in a mapping verification process according to the second embodiment;

FIG. 17 is a diagram illustrating one example of a method for utilization of the mapping result verification apparatus; and

FIG. 18 is a diagram of a hardware configuration of the mapping result verification apparatus.

### DESCRIPTION OF EMBODIMENTS

However, it is difficult to prove correctness of the program for the automatic mapper based on the own information, and it is important to guarantee that the mapping result is correct by using another method. Furthermore, it is conceivable to manually perform the mapping in the same way as in a case where speedup is implemented by partially and manually writing a code by using an inline assembler, and it is important to guarantee manual tuning of the mapping result obtained by the automatic mapper and guarantee correctness of the result of the mapping that has been manually performed.

As a standard test method, it is conceivable to use a method for comparing a calculation result obtained from the CGRA in a case where some input values are given with a calculation result of calculation performed in accordance with the DFG, but it is impractical to perform verification on all the input values. Furthermore, in a case of the comparison between the calculation results, it is difficult to detect which of the PE in which setting is incorrect by tracking the flow of the value to be calculated, and thus it is difficult to correct the automatic mapper. As a result of this, it is difficult to improve the accuracy of the mapping with respect to the CGRA by comparing the calculation results.

In addition, the technology for verifying the logical equivalence of the circuits by comparing data obtained before and after the processing steps of the logic synthesis corresponds to a comparison between the calculation results of each of the parts, and it is difficult to improve the accuracy of the mapping with respect to the CGRA.

Preferred embodiments will be explained with reference to accompanying drawings. Furthermore, the mapping result verification program, the mapping result verification method, and the mapping result verification apparatus disclosed in the present application are not limited to the embodiments.

### (a) First Embodiment

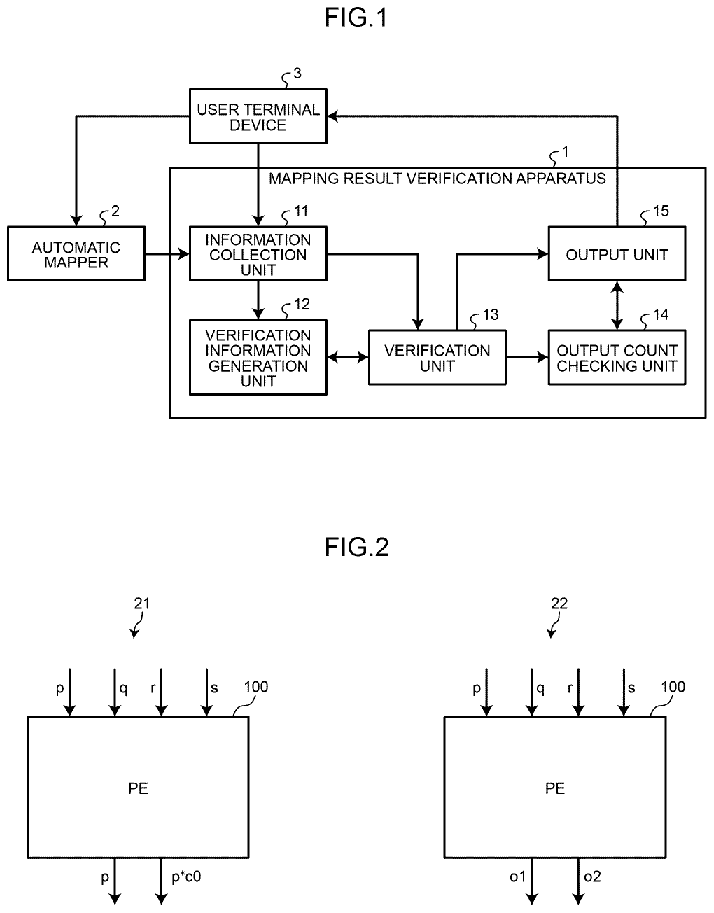

FIG. 1 is a block diagram of a mapping result verification apparatus. A mapping result verification apparatus 1 according to the present embodiment is connected to an automatic mapper 2 and a user terminal device 3.

The user terminal device 3 is a terminal device that is used by a user who uses an information processing apparatus (not illustrated) having installed therein a CGRA. The CGRA includes a plurality of PEs that are arithmetic operation units. The user designs a data flow graph (DFG) for operating the CGRA. The DFG is a diagram that indicates both of the flow of data and arithmetic operations to be performed in a system that causes a calculation to be performed. Here, the subject to be performed by the DFG as a whole is referred to as a “calculation”, and a plurality of “arithmetic operations” are included in the “calculation”. The user terminal device 3 transmits the DFG that has been designed by the user to the automatic mapper 2, and causes the automatic mapper 2 to perform mapping into the CGRA. In addition, in order to verify the mapping result obtained by the automatic mapper 2, the user terminal device 3 transmits the DFG that has been designed by the user to the mapping result verification apparatus 1.

The automatic mapper 2 receives the DFG that is to be mapped into the CGRA from the user terminal device 3. The automatic mapper 2 holds in advance the configuration information on the CGRA that is targeted for the mapping. Then, the automatic mapper 2 maps the received DFG into the CGRA. The mapping mentioned here is a process of allocating an arithmetic operation defined in the DFG to any one of the PEs that are included in the CGRA, deciding a connection between the PEs such that each of the arithmetic operations that have been defined in the DFG is performed in accordance with the data flow, and constituting the CGRA so as to be able to perform a calculation indicated in the DFG. The automatic mapper 2 transmits the mapping result to the mapping result verification apparatus 1 for the purpose of mapping result verification.

In the following, the mapping result verification apparatus 1 will be described. The mapping result verification apparatus 1 includes an information collection unit 11, a verification information generation unit 12, a verification unit 13, an output count checking unit 14, and an output unit 15.

The information collection unit 11 receives the DFG that has been designed by the user from the user terminal device 3. Furthermore, the information collection unit 11 receives the mapping result of the DFG obtained by the automatic mapper 2. Then, the information collection unit 11 outputs the DFG and the mapping result to each of the verification information generation unit 12 and the verification unit 13.

As described above, the information collection unit 11 acquires both of the data flow graph that represents a predetermined calculation including a plurality of arithmetic operations and the mapping result that has been obtained by mapping the data flow graph into the CGRA that includes a plurality of arithmetic operation units. Furthermore, the PE to which the arithmetic operation defined in the DFG has been allocated as a result of the mapping performed by the automatic mapper 2 corresponds to one example of a “first arithmetic operation unit”. Then, the process of acquiring includes a process of acquiring the mapping result in which the information that is output from the first arithmetic operation unit and that includes the arithmetic operation result is used as the information that is input to another arithmetic operation unit or as the calculation result of the predetermined calculation.

Here, the mapping result includes information indicating that from where each of the PEs included in the mapped CGRA receives an input of a signal, what kind of calculation each of the PEs performs, and what kind of signal each of the PEs outputs to where. As an input source, an input node corresponding to an input source that receives an input of the initial information or another PE is present. Furthermore, as an output destination, the other PE or a result output is present.

FIG. 2 is a diagram illustrating one example of a representation method of representing mapping performed on the PE. Representations 21 and 22 illustrated in FIG. 2 each indicates information on the representation method of different mappings about each of the PEs 100. Conceptually, regarding each of the PEs 100, mapping can be represented by the information that will be described below.

The mapping result includes, as the first information, information on the input ports that are used by the respective PEs 100. As the information on the input port, identification information on the input ports is used. In both of the representations 21 and 22, each of the symbols of p, q, r, and s denotes the identification information on the corresponding input ports. Hereinafter, for example, the input port having the identification information denoted by p is sometimes referred to as the input port denoted by p.

Furthermore, the mapping result includes, as the second information, an output value that has been output from each of the output ports provided in the respective PEs 100. In the representation 21, it is indicated that the output value from one of the output ports is p and the output value from the other of the output ports is p*c0. Here, p*c0 denotes an arithmetic operation that is performed in the PE 100, and c0 denotes a constant that is stored in the PE 100. In this case, it is indicated that input values to the input ports denoted by q, r, and s are not used.

Moreover, as indicated by the representation 21, if the arithmetic operation expression is used as the output value without any change, it is conceivable that the representation 21 becomes complicated. In this case, as indicated by the representation 22, it may be possible to represent the output value by using the identification information on the output port as the output value, and separately holding the arithmetic operation expression corresponding to the subject identification information. For example, the representation 22 includes the output ports each having the identification information denoted by o1 and o2, and indicates that the output values from the respective output ports are o1 and o2, respectively. In addition, in a case where, in also the representation 22, the output values are the same as those of the representation 21, in the representation 22, information, such as o1=p and o2=p*c0, is separately held. Hereinafter, for example, the output port having the identification information denoted by o1 is sometimes referred to as the output port denoted by o1.

In addition, as the third information, the mapping result includes a node ID of the node that is included in the DFG and that has been mapped into each of the PEs 100. If these three pieces of information are included in the mapping result, it is possible to represent, in the CGRA, the mapping performed onto each of the PEs 100. In the description below, each of the PEs is referred to as the PE 100.

The verification information generation unit 12 receives an input of both of the DFG and the mapping result from the information collection unit 11. In the following, the verification information generation unit 12 regards the timing of an output from the input node as a zeroth cycle, and sets a virtual output value that has been output from the PE 100 corresponding to the input node as an output value of the zeroth cycle. Then, the verification information generation unit 12 outputs the generated output value to the verification unit 13.

In a case where the input value is output by the PE 100 without any change, the verification information generation unit 12 sets the input value as an output value. Furthermore, in the present embodiment, the arithmetic operation result that is obtained from symbolic execution that performs a symbol calculation of algebra by using a symbol as a value is used for the verification of the arithmetic operation performed in the PE 100. Accordingly, the output value at the time of a case in which the arithmetic operation result obtained from the PE 100 performed by using the input value corresponds to the arithmetic operation result indicated by using the symbol. However, a subsequent arithmetic operation to be performed in the subsequent PE 100 by using the subject output value is also the symbolic execution, so that the verification information generation unit 12 further abstracts the output value, and sets the identification information on the PE 100 that outputs the subject arithmetic operation result as the output value. In this way, by replacing the arithmetic operation result with the identification information on the PE 100 that is the output source and by outputting the replaced identification information, the verification information generation unit 12 is able to avoid the output value from being complicated value and is able to simplify the verification of the calculation.

After that, when the verification information generation unit 12 receives a notification of the verified validity about the first cycle from the verification unit 13, the verification information generation unit 12 generates an output value to be output from each of the PEs 100 at the first cycle. Then, the verification information generation unit 12 outputs the generated output values to the verification unit 13.

When the verification information generation unit 12 receives a notification of the verified validity from the verification unit 13, the verification information generation unit 12 sequentially generates an output value to be output from each of the PEs 100 at the next cycle and outputs the generated output values to the verification unit 13 until the PE 100 that outputs the subsequent signal is not present any more. Furthermore, in a case where the verification information generation unit 12 has received a notification of a verification suspension from the verification unit 13, the verification information generation unit 12 suspends the generation of the output value at that point. In this way, the verification information generation unit 12 generates the verification information that includes the information on the output value that has been output from each of the PEs 100 and that is used by the mapping result.

The verification unit 13 sequentially receives an input of the output value that has been output from each of the PEs 100 at each cycle in the order of cycles starting from the zeroth cycle. Then, the verification unit 13 performs the verification described below on the PE 100 in which an output value that has been output at one previous cycle is input.

As the first verification, the verification unit 13 checks that all of the outputs that are input to the subject PE 100 and that are to be used are obtained at the cycle located one previous cycle. Here, the output indicates that an output value that has been output from the specific PE 100 is transmitted. In other words, a state in which an output is able to be obtained indicates a state in which an output received from the PE 100 that is the output source of the output value that is used for the arithmetic operation is able to be obtained. Here, the verification unit 13 is able to acquire, from the architecture designed for the CGRA, the signal that is output from the PE 100 that is connected to each of the ports that are provided in the subject PE 100. The information on the architecture designed for the CGRA includes the number of routing lines between the PEs 100 and the connection information on the connection between each of the PEs 100.

In a case where an output that is not able to be obtained from among the outputs that are used in the subject PE 100, the verification unit 13 outputs a notification of the invalidation of the mapping to the output unit 15. Furthermore, the verification unit 13 outputs a notification of a verification suspension to the verification information generation unit 12.

As the second verification, the verification unit 13 checks that the output values that are obtained at the one previous cycle are matched with all of the output values output from the PE 100 that is the input source and that is indicated in the DFG, and also, checks that the arithmetic operation performed in the PE 100 matches the arithmetic operation that has been specified in the DFG. Here, the verification unit 13 checks the sameness of the arithmetic operations on the basis of the arithmetic operation result obtained in a case where the arithmetic operation to be performed in the PE 100 has been subjected to symbolic execution. Furthermore, in a case where a conditional branch is present in the arithmetic operation that is performed in the PE 100, the verification unit 13 checks the conditional branch as a constraint condition, and is able to check that the process does not reach the conditional branch in a case where the constraint condition is contradictory.

In a case where an output value that does not match the output values output from the PE 100 that is the input source and that is indicated in the DFG is present from among the output values obtained at one previous cycle, the verification unit 13 outputs a notification of invalidation of the mapping to the output unit 15. Furthermore, in also a case in which the arithmetic operation performed in the PE 100 is different from the arithmetic operation that has been specified in the DFG, the verification unit 13 outputs a notification of the invalidation of the mapping to the output unit 15. In addition, the verification unit 13 outputs the notification of a verification suspension to the verification information generation unit 12.

In a case where the validity of the mapping result indicated at the subject cycle has been checked on the basis of the first verification and the second verification, the verification unit 13 outputs a notification of the verified validity to the verification information generation unit 12. Furthermore, in a case where the subsequent PE 100 in which an output value is to be input is not present, the verification unit 13 regards the subject output value as one of the calculation result outputs obtained in the CGRA.

Then, if the PE 100 that operates for all of the output values in the next cycle is not present any more, the verification unit 13 outputs the output value that corresponds to the calculation result output indicated in the CGRA to the output count checking unit 14 together with the DFG.

Here, the symbolic execution corresponds to “execution of an arithmetic operation performed by using a symbol”. In other words, the verification unit 13 verifies whether or not the mapping result matches the data flow graph by using the arithmetic operation result that has been obtained by performing the arithmetic operation by using the symbol. Furthermore, the process of the verification includes a process of comparing the verification information that is generated by the verification information generation unit 12 with the information on the output value of the arithmetic operation indicated in the data flow graph. Furthermore, the process of the verification includes a process of verifying whether or not the mapping result matches the data flow graph by comparing the information that corresponds to an input of the arithmetic operation that is allocated to each of the first arithmetic operation units and that is indicated in the data flow graph with the information that is input to each of the first arithmetic operation units and that is indicated in the mapping result. Furthermore, the process of the verification includes a process of comparing, on the basis of the information that indicates a connection relationship between the arithmetic operation units, the information that corresponds to an input of the arithmetic operation that is allocated to the first arithmetic operation unit and that is indicated in the data flow graph with the information that is input to the first arithmetic operation unit and that is indicated in the mapping result.

The output count checking unit 14 receives both of an input of the information on the output value that corresponds to the calculation result output indicated in the CGRA and an input of the DFG from the verification unit 13. Then, the output count checking unit 14 determines whether or not the number of output values that is regarded as the calculation result output indicated in the CGRA matches the number of outputs of the calculation result specified in the DFG.

In a case where the number of output values regarded as the calculation result output indicated in the CGRA matches the number of outputs of the calculation result specified in the DFG, and also, in a case where the output node specified in the DFG matches the output from the CGRA, the output count checking unit 14 determines that the verification has been successful. Then, the output count checking unit 14 outputs a notification that the mapping result is valid to the output unit 15. Furthermore, in a case where the number of output values regarded as the calculation result output indicated in the CGRA does not match the number of outputs of the calculation result specified in the DFG, the output count checking unit 14 outputs the notification of the invalidation of mapping to the output unit 15. In this way, the output count checking unit 14 compares the number of calculation results indicated in the data flow graph with the number of calculation results obtained from the mapping result.

When the output unit 15 receives an input of a notification of the invalidation of the mapping from the verification unit 13, the output unit 15 transmits the notification of the invalidation of the mapping to the user terminal device 3. Furthermore, when the output unit 15 receives an input of the notification that the mapping result is valid from the output count checking unit 14, the output unit 15 transmits the notification that the mapping result is valid to the user terminal device 3.

In the following, the validity of the mapping result will be described. In a case where a node corresponding to an output of the DFG has been checked by the verification performed by the mapping result verification apparatus 1, soundness and completeness have been guaranteed, and it is also guaranteed that mapping is correctly performed and the calculation results match. As a premise, it is assumed that, in the mapping, only a single DFG is used as a target, and it is assumed that data is allowed to pass through the PE 100 in which an arithmetic operation is not allocated without stopping. In other words, in a specific DFG, in a case where an arithmetic operation that uses an interim arithmetic operation result has been added, or in a case where a different arithmetic operation has been added, the DFG becomes a different DFG in which a DFG has been added.

The soundness means that something that can be proven is right, and here, the soundness indicates that a portion corresponding to the DFG is present in the mapped calculation. The following content is guaranteed by the verification performed by the mapping result verification apparatus 1, so that the soundness is guaranteed. Firstly, it is guaranteed that the mapped calculation is present in the DFG and does not include an excessive arithmetic operation. Secondly, it is guaranteed that there is no case in which the PE 100 does not perform an arithmetic operation in which a node included in the DFG is not allocated. Thirdly, it is guaranteed that an input to the PE 100 in which a node included in the DGG has been allocated matches an input that is defined in the DFG.

Furthermore, the completeness means that the right thing can be proven, and here, the completeness indicates that the calculation of the DFG is performed in the mapped CGRA. In the verification performed in the mapping result verification apparatus 1, if all of the nodes included in the DFG are allocated to the PEs 100, it is guaranteed that the calculation performed in all of the allocated PEs 100 matches the content of the calculation performed at each of the nodes included in the DFG, so that the completeness is guaranteed.

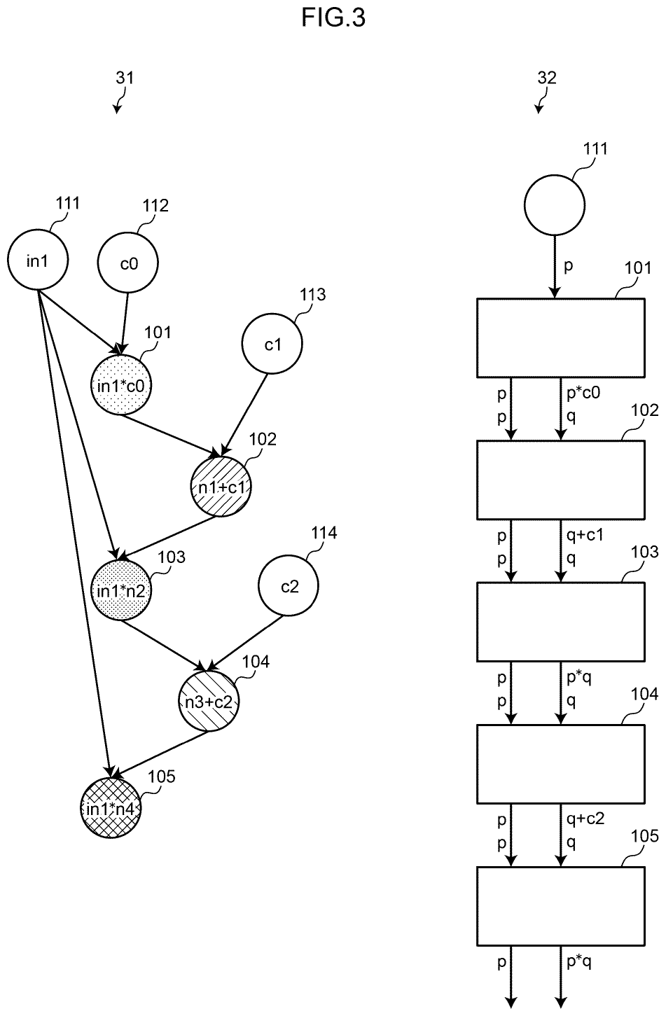

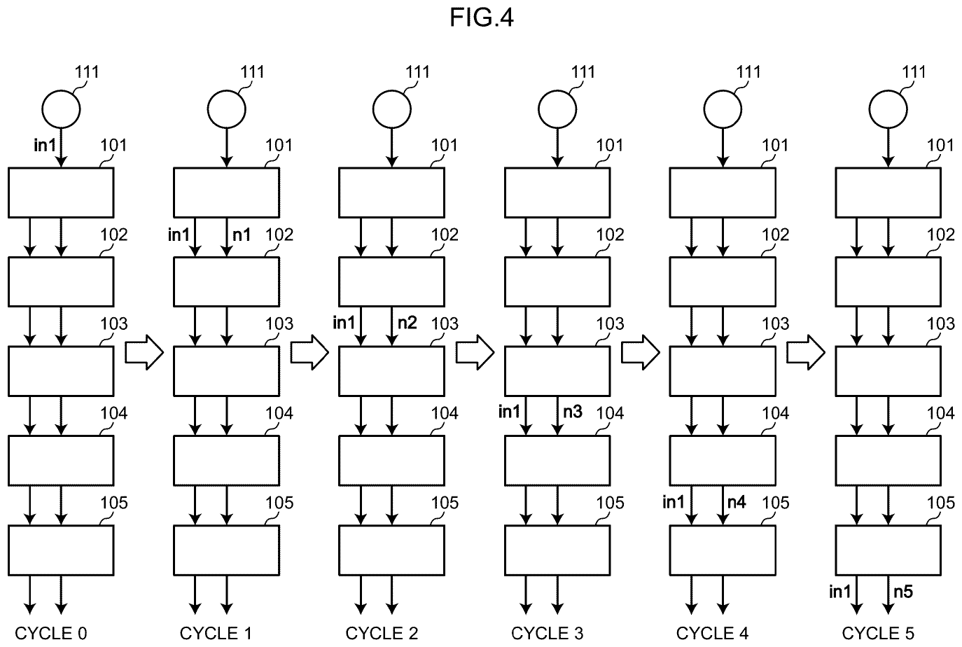

In the following, a specific example of the mapping result verification will be described. FIG. 3 is a diagram illustrating one example of the DFG and a mapping result. Furthermore, FIG. 4 is a diagram illustrating the outline of a mapping result verification process. Here, the outline of the mapping result verification process will briefly be described with reference to FIGS. 3 and 4.

The information collection unit 11 receives a DFG 31 and a mapping result 32. Nodes 101 to 105 included in the DFG 31 are nodes each performing an arithmetic operation assigned in the DFG. Furthermore, information described in each of the nodes 101 to 105 indicates an arithmetic operation performed in each of the nodes 101 to 105.

A node 111 is an input node for an input to the CGRA received from the outside. Furthermore, a node 112 is an input node that gives a fixed value that is used for the calculation performed in the node 101. A node 113 is an input node that gives a fixed value that is used for the calculation performed in the node 102. A node 114 is an input node that gives a fixed value that is used for the arithmetic operation performed in the node 104. Here, the output value that is output from each of the nodes 112 to 114 is a value that is practically held in advance by each of the corresponding nodes 101, 102, and 104, but, in the DFG 31, the output value is treated as an output value that is output from the input node. Furthermore, the information described in each of the nodes 111 to 114 indicates the output value that is output from each of the corresponding nodes 111 to 114.

Here, as the output value that is used for the arithmetic operation that is performed by each of the nodes 102 to 105 illustrated in FIGS. 3 and 4, the output values that are output from the nodes 101 to 104 are denoted by n1 to n4, respectively. For example, the node 102 performs the arithmetic operation that adds n1 that is the output value that has been output from the node 101 and c1 that is the output value that has been output from the node 113.

The mapping result 32 indicates a state in which the nodes 101 to 105 are allocated to respective five PEs 100 that are included in in the CGRA. Hereinafter, the PEs 100 in which the nodes 101 to 105 are allocated are referred to as the nodes 101 to 105, respectively. The mapping result 32 includes an input port name of an input port that receives an input of both of the information on an output value and the output value related to each of the nodes 101 to 105. Here, the mapping result 32 has been schematically illustrated, but, in practice, the mapping result 32 is information in which an input to and an output from each of the PEs 100 and an arithmetic operation performed by the PE 100 are described. In the mapping result 32, the output value that is output from each of the nodes 112 to 114 is an eigenvalue held by each of the nodes 101, 102, and 104.

The mapping result verification process is performed on the basis of the DFG 31 and the mapping result 32 in accordance with the procedure illustrated in FIG. 4. FIG. 4 illustrates a state of an input and an output of a signal that is sent to and from at 0 to 5 cycles.

The verification information generation unit 12 regards in1 that is the output value output from the node 111 as the output value at the zeroth cycle.

The verification unit 13 performs verification about the node 101 that receives, at the first cycle, an input of the output value that has been output at the zeroth cycle. The verification unit 13 checks that an output that has been output from the node 111 and that is to be input to the input port that is denoted by p and that is included in the node 101 is equal in the mapping result 32. Then, the verification unit 13 checks that in1 that is the output value used by the node 101 and that is the output value received from the node 111 is present. In addition, the verification unit 13 checks, from the mapping result 32, that p*c0 corresponding to in1*c0 is performed by the node 101.

After that, the verification information generation unit 12 checks that in1 and the arithmetic operation result are output from the node 101. Then, the verification information generation unit 12 regards the input value of in1 that is to be input to the node 101 as the output value that is output from the node 101 at the first cycle without any change, and then, regards, for the arithmetic operation result, n1 that is the identification information on the node 101 as the output value from the node 101 at the first cycle.

The verification unit 13 performs verification about the node 102 that receives, at the second cycle, an input of each of the output values that have been output at the first cycle. The verification unit 13 checks that the outputs that have been output from the node 101 and that are to be input to the corresponding input ports that are denoted by p and q and that are included in the node 102 are equal in the mapping result 32. Then, the verification unit 13 checks that in1 and n1 that are the output values used by the node 102 and that are the output values that have been output from the node 101 are present. In addition, the verification unit 13 checks, from the mapping result 32, that q+c1 corresponding to n1+c1 that is the arithmetic operation designated in the DFG 31 is performed in the node 102.

Then, the verification information generation unit 12 checks that in1 and the arithmetic operation result are output from the node 102. Then, the verification information generation unit 12 regards the input value of in1 that is to be input to the node 102 as the output value that is output from the node 102 at the second cycle without any change, and then, regards, for the arithmetic operation result, n2 that is the identification information on the node 102 as the output value of the node 102 at the second cycle.

The verification unit 13 performs verification about the node 103 that receives, at the third cycle, an input of each of the output values that have been output at the second cycle. The verification unit 13 checks that the outputs that have been output from the node 102 and that are to be input to the corresponding input ports that are denoted by p and q and that are included in the node 103 are equal in the mapping result 32. Then, the verification unit 13 checks that in1 and n2 that are the output values used by the node 103 and that are the output values that have been output from the node 102 are present. In addition, the verification unit 13 checks, from the mapping result 32, that p*q corresponding to in1*n2 that is the arithmetic operation designated in the DFG 31 is performed in the node 103.

Then, the verification information generation unit 12 checks that in1 and the arithmetic operation result are output from the node 103. Then, the verification information generation unit 12 regards the input value of in1 that is to be input to the node 103 as the output value of the node 103 at the third cycle without any change, and then, regards, for the arithmetic operation result, n3 that is the identification information on the node 103 as the output value of the node 103 at the third cycle.

The verification unit 13 performs verification about the node 104 that receives, at the fourth cycle, an input of each of the output values that have been output at the third cycle. The verification unit 13 checks that the outputs that have been output from the node 103 and that are to be input to the corresponding input ports denoted by p and q and that are included in the node 104 are equal in the mapping result 32. Then, the verification unit 13 checks that in1 and n3 that are the output values used by the node 104 and that are the output values received from the node 103 are present. In addition, the verification unit 13 checks, from the mapping result 32, that q+c2 corresponding to n3+c2 that is the arithmetic operation designated in the DFG 31 is performed in the node 104.

Then, the verification information generation unit 12 checks that in1 and the arithmetic operation result are output from the node 104. Then, the verification information generation unit 12 regards the input value of in1 that is to be input to the node 104 as the output value of the node 104 at the fourth cycle without any change, and then, regards, for the arithmetic operation result, n4 that is the identification information on the node 104 as the output value of the node 104 at the fourth cycle.

The verification unit 13 performs verification about the node 105 that receives, at the fifth cycle, an input of each of the output values that have been output at the fourth cycle. The verification unit 13 checks that the outputs that have been output from the node 104 and that are to be input to the corresponding input ports that are denoted by p and q and that are included in the node 105 are equal in the mapping result 32. Then, the verification unit 13 checks that in1 and n4 that are the output values used by the node 105 and that are the output values received from the node 104 are present. In addition, the verification unit 13 checks, from the mapping result 32, that p*q corresponding to in1*n4 that is the arithmetic operation designated in the DFG 31 is performed in the node 105.

Then, the verification information generation unit 12 checks that in1 and the arithmetic operation result are output from the node 105. Then, the verification information generation unit 12 regards the input value of in1 that is to be input to the node 105 as the output value of the node 105 at the fifth cycle without any change, and then, regards, for the arithmetic operation result, n5 that is the identification information on the node 105 as the output value of the node 105 at the fifth cycle.

The verification unit 13 checks that PE 100 in which the output value from the node 105 is to be input at the fifth cycle is not present. In this case, the PE 100 that is an input destination for the output value is not present, so that the verification unit 13 regards the output from the node 105 as the calculation result. An explanation of a check of the number of outputs performed by the output count checking unit 14 will be omitted here.

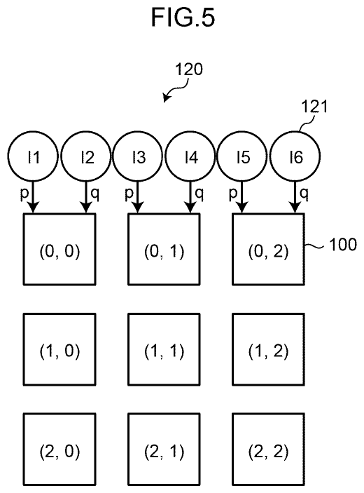

In the following, a specific example of the mapping result verification will be described in further detail. FIG. 5 is a diagram illustrating one example of the CGRA targeted for the mapping. A CGRA 120 has a structure in which the PEs 100 are arranged in a 3×3 array. For the explanation, numbers each indicating a location of the corresponding PEs 100 are illustrated in FIG. 5. Here, each of the PEs 100 is represented by the number that indicates the corresponding location. In other words, the CGRA 120 includes the PEs 100 located at (0, 0), (0, 1), (0, 2), (1, 0), (1, 1), (1, 2) (2, 0), (2, 1) and (2, 2). Each of the PEs 100 includes the input ports and the output ports that are illustrated in FIG. 2. Furthermore, an input of the input value received from the outside is performed on each of the ports that are denoted by p and q and that are included in each of the PEs 100 located at (0, 0), (0, 1), and (0, 2). The information described in each of input nodes 121 corresponds to the output value that is output from each of the input nodes 121.

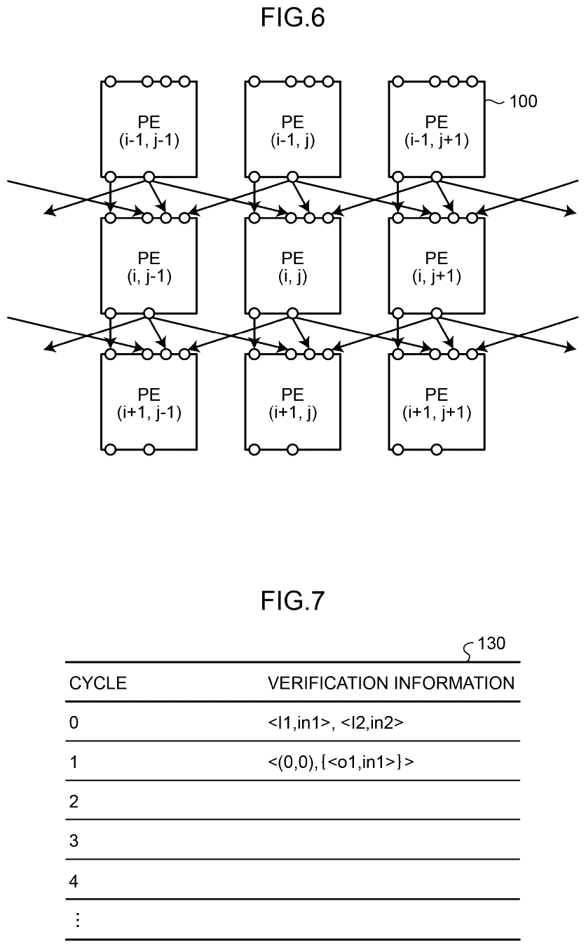

FIG. 6 is a diagram illustrating one example of each of connections between the PEs. Here, as illustrated in FIG. 6, each of the PEs 100 are connected. In other words, in a case where the representation 22 illustrated in FIG. 2 is used for the explanation, the output port that is denoted by o1 and that is provided in the PE 100 located at (i, j) is connected to the input port that is denoted by p and that is provided in the PE 100 located at (i+1, j). Furthermore, the output port that is denoted by o2 and that is provided in the PE 100 is connected to the input port that is denoted by q and that is provided in the PE 100 located at (i+1, j−1), and is connected to both of the output port that is denoted by r and that is provided in the PE 100 located at (i+1, j) and the output port that is denoted by s and that is provided in the PE 100 located at (i+1, j+1).

FIG. 7 is a diagram illustrating one example of a verification information list. The verification information generation unit 12 obtains the output value of each of the PEs 100 at each of the cycles, and registers each of the obtained output values in a field of the corresponding cycle indicated in a verification information list 130. Here, the verification information generation unit 12 uses a combination of the output port and the output value from the location of the PE 100 as the verification information. For example, the verification information generation unit 12 generates the information, such as <location of the PE 100, {<identification information on the output port, the output value>}>, as the verification information. The output that has been output at the first cycle indicated in the verification information list 130 illustrated in FIG. 5 indicates that in1 has been output as the output value from the output port that is denoted by o1 and that is provided in the PE 100 located at (0, 0). However, the zeroth cycle corresponds to the output that is performed from the input node, so that the verification information generation unit 12 regards a combination of the identification information on the input node and the output value as the verification information.

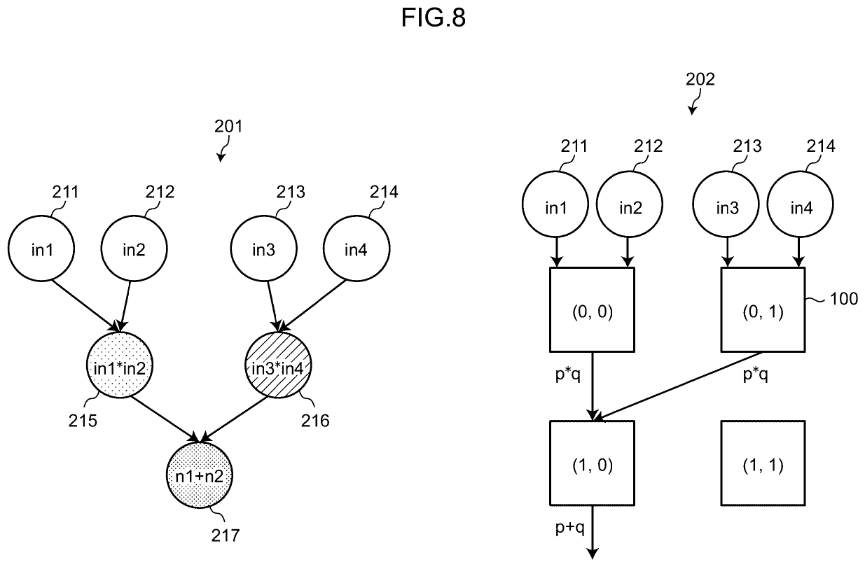

The mapping result verification process will be described on the basis of the described above. FIG. 8 is a diagram illustrating one example of the DFG and the mapping result that are used for the explanation of the mapping result verification process. A DFG 201 includes nodes 211 to 214 and nodes 215 to 217. In this description, the identification information on the nodes 211 to 214 that are the input nodes are referred to as I1 to I4, respectively. Furthermore, the identification information on the nodes 215 to 217 are referred to as n1 to n3, respectively. Then, the output value of the node 215 is denoted by n1 that is the identification information on the node 215. Furthermore, the output value of the node 216 is referred to as n2 that is the identification information on the node 216.

The node 215 multiplies the output value of the node 211 by the output value of the node 212. The node 216 multiplies the output value of the node 213 by the output value of the node 214. Furthermore, the node 217 adds n1 that is the output value of the node 215 to n2 that is the output value of the node 216.

Then, the node 215 included in the DFG 201 is mapped into the PE 100 located at (0, 0) indicated in a mapping result 202. Furthermore, the node 216 included in the DFG 201 is mapped into the PE 100 located at (0, 1) indicated in the mapping result 202. Furthermore, the node 217 included in the DFG 201 is mapped into the PE 100 located at (1, 0) indicated in the mapping result 202.

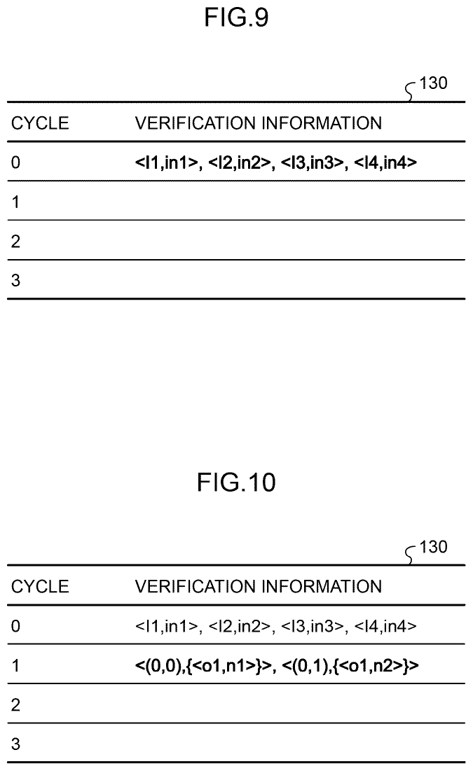

FIG. 9 is a diagram illustrating in the verification information list in which each of the outputs performed at the zeroth cycle has been registered. In FIG. 9, in1 to in4 are output as the output values from the nodes 111 to 114, respectively, that are the four input nodes at the zeroth cycle. Accordingly, as illustrated in FIG. 9, the verification information generation unit 12 registers, in the verification information list 130, the verification information indicating a combination of I1 to I4 that are the identification information on the nodes 111 to 114, respectively, and in1 to in4 that are the output values from each of the corresponding input nodes. Then, the verification information generation unit 12 outputs the verification information list 130 in which the registration has been completed to the verification unit 13.

The verification unit 13 checks the verification information list 130. Then, the verification unit 13 performs verification on the PE 100 that is located at (0, 0) and that uses the output value that has been output at the zeroth cycle. The verification unit 13 checks that an input to the PE 100 located at (0, 0) is an output from the input nodes having the identification information denoted by I1 and I2, checks that an output from each of the input nodes having the identification information denoted by I1 and I2 is present at the zeroth cycle indicated in the verification information list 130.

Then, the verification unit 13 checks that the output values that are used by the node that is allocated to the PE 100 located at (0, 0) in the DFG 201 are in1 and in2. Furthermore, on the basis of the connection information on the CGRA 120, the verification unit 13 checks that the output value with respect to the input port denoted by p included in the PE 100 located at (0, 0) is the output value of the input node having the identification information denoted by I1, and checks that the output value with respect to the input port denoted by q is the output value of the input node having the identification information denoted by I2. Then, the verification unit 13 checks that the output value of the input node having the identification information denoted by I1 is in1, and checks that the output value of the input node having the identification information denoted by I2 is in2. Accordingly, the verification unit 13 is able to check that the values of the signals obtained at the zeroth cycle match all of the values of the signals that are output from the PE 100 corresponding to the input source. Furthermore, it is possible to check that the arithmetic operation that is allocated to the PE 100 located at (0, 0) is in1*in2 and matches the arithmetic operation that has been designated in the DFG 201.

The verification unit 13 similarly performs the verification on the PE 100 that is located at (0, 1) that uses the output value that has been output at the zeroth cycle. If the verification performed on both of the PEs 100 is successful, the verification unit 13 outputs a notification of verified validity to the verification information generation unit 12.

FIG. 10 is a diagram illustrating the verification information list in which the outputs performed at the first cycle have been registered. As illustrated in FIG. 10, the verification information generation unit 12 generates the verification information on the PEs 100 that are located at (0, 0) and (0, 1) and that performs the arithmetic operation at the first cycle. For example, an arithmetic operation result is output from the output port that is denoted by o1 and that is provided in the PE 100 located at (0, 0). Accordingly, the verification information generation unit 12 registers, regarding the PE 100 located at (0, 0), the verification information indicating that the identification information on the PE 100 located at (0, 0) has been output from the output port denoted by o1 at the first cycle indicated in the verification information list 130. In other words, as illustrated in FIG. 10, the verification information generation unit 12 registers <(0, 0>, <{o1, n1>}> in the verification information list 130. Similarly, as illustrated in FIG. 10, the verification information generation unit 12 registers <(0, 1>, <{o1, n2>}> in the verification information list 130.

The verification unit 13 checks the verification information list 130. Then, the verification unit 13 performs the verification on the PE 100 that is located at (1, 0) and that uses the output value that has been output at the first cycle. The inputs performed by the PE 100 located at (1, 0) are the output values from the PEs 100 located at (0, 0) and (0, 1), and the verification unit 13 checks that the output values from the PEs 100 located at (0, 0) and (0, 1) are present in the first cycle indicated in the verification information list 130.

After that, the verification unit 13 checks that the output values that are used by the node that has been allocated to the PE 100 located at (1, 0) in the DFG 201 are n1 and n2. Furthermore, on the basis of the connection information indicated in the CGRA 120, the verification unit 13 checks that the output value with respect to the input port that is denoted by p and that is provided in the PE 100 located at (1, 0) is the output value of the PE 100 located at (0, 0), and checks that output value with respect to the input port denoted by q is the output value of the PE 100 located at (0, 1). Then, the verification unit 13 checks that the output value of the PE 100 located at (0, 0) is n1 and checks that the output value of the PE 100 located at (0, 1) is n2. Accordingly, the verification unit 13 is able to check that values of the signals obtained at the first cycle match all of the values of the signals that are output from the PE 100 corresponding to the input source. Furthermore, it is possible to check that the arithmetic operation that is allocated to the PE 100 located at (1, 0) is n1+n2 and matches the arithmetic operation that has been designated in the DFG 201. If the verification performed on the PE 100 located at (1, 0) has been successful, the verification unit 13 outputs a notification of the verified validity to the verification information generation unit 12.

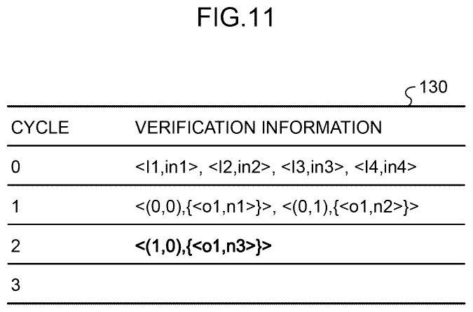

FIG. 11 is a diagram illustrating the verification information list in which an output of the second cycle has been registered. As illustrated in FIG. 11, the verification information generation unit 12 generates the verification information on the PE 100 that is located at (1, 0) and that has performed the arithmetic operation at the second cycle. For example, an arithmetic operation result is output from the output port that is denoted by o1 and that is provided in the PE 100 located at (1, 0). Accordingly, the verification information generation unit 12 registers, regarding the PE 100 located at (1, 0), the verification information indicating that the identification information on the PE 100 located at (1, 0) has been output from the output port denoted by o1 at the second cycle indicated in the verification information list 130. In other words, as illustrated in FIG. 11, the verification information generation unit 12 registers <(1, 0>, {<o1, n3>}> in the verification information list 130.

The verification unit 13 regards the output value that has been output at the second cycle as the calculation result output on the basis that the PE 100 that uses the output value at the second cycle is not present. In this case, the output count checking unit 14 determines that the verification has been successful on the basis that the number of outputs of the calculation result in the DFG 201 is one and matches the number of calculation result outputs, and then, the output count checking unit 14 outputs the notification that the mapping result is valid to the output unit 15.

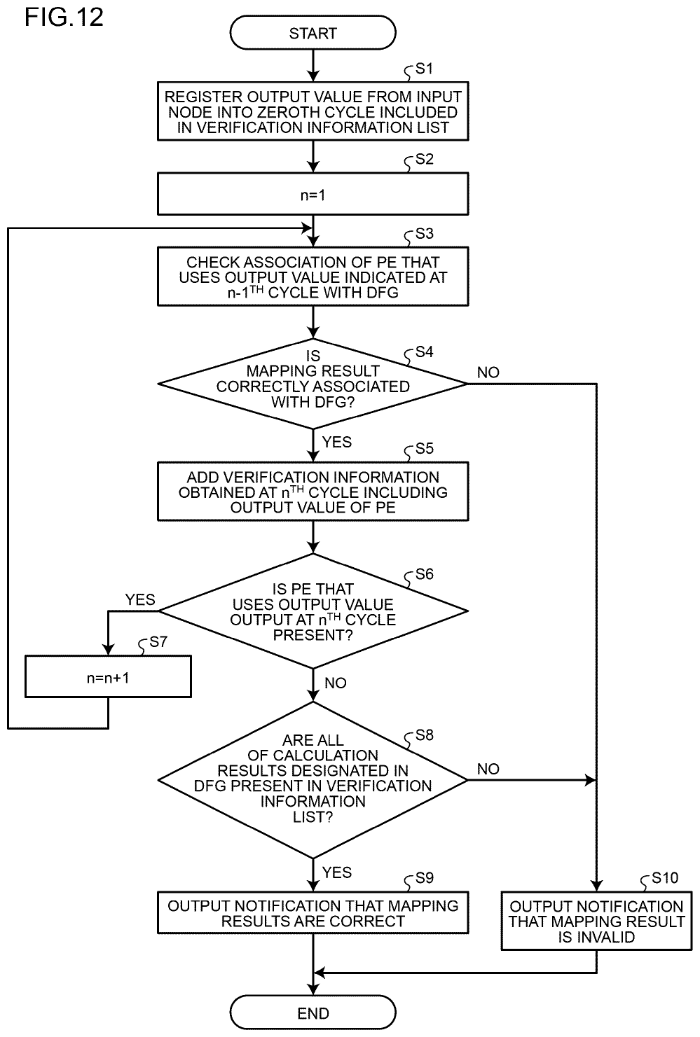

FIG. 12 is a flowchart illustrating the mapping result verification process according to the first embodiment. In the following, the flow of the mapping result verification process according to the first embodiment will be described with reference to FIG. 12.

The verification information generation unit 12 registers the output value received from the input node into the zeroth cycle included in the verification information list 130 (Step S1).

In the following, each of the verification information generation unit 12 and the verification unit 13 initializes n and sets the initialized n to 1 (Step S2).

After that, the verification unit 13 checks association of the PE 100 that uses the output value indicated at an n−1^{th} cycle with the DFG (Step S3).

Then, the verification unit 13 determines whether or not the mapping result related to the PE 100 that uses the output value that is output at the n−1^{th} cycle is correctly associated with the PE 100 indicated in the DFG (Step S4).

If the PE 100 is correctly associated with the output value indicated in the DFG (Yes at Step S4), the verification information generation unit 12 additionally registers the verification information that has been obtained at the n^{th} cycle and that includes the output value of the PE 100 into the n^{th} cycle included in the verification information list 130 (Step S5).

After that, the verification unit 13 determines whether or not the PE 100 that uses the output value that has been output at the n^{th} cycle is present (Step S6).

If the PE 100 that uses the output value that has been output at the n^{th} cycle is present (Yes at Step S6), each of the verification information generation unit 12 and the verification unit 13 increments n by one (Step S7). After that, the mapping result verification process returns to Step S3.

In contrast, if the PE 100 that uses the output value that has been output at the n^{th} cycle is not present (No at Step S6), the output count checking unit 14 determines whether or not all of the calculation results designated in the DFG are present in the verification information list 130 as the calculation results (Step S8).

If all of the calculation results designated in the DFG are present in the verification information list 130 as the calculation results (Yes at Step S8), the output unit 15 outputs a notification that the mapping results are correct to the user terminal device 3 (Step S9).

In contrast, if the output value is not correctly associated with the output value indicated in the DFG (No at Step S4), and also, if some of the calculation result designated in the DFG is not present in the verification information list 130 from among the calculation results designated in the DFG (No at Step S8), the following process if performed. In other words, the output unit 15 outputs a notification that the mapping result is invalid to the user terminal device 3 (Step S10).

As described above, the mapping result verification apparatus 1 according to the present embodiment checks that the mapping result indicates the same data flow indicated in the DFG by using the symbolic execution on the arithmetic operation performed at each of the nodes. By performing the arithmetic operation by using the abstract values instead of using test data, the mapping result verification apparatus 1 is able to perform the verification that is similar to comprehensive verification at low cost. Therefore, it is possible to improve the accuracy of the mapping with respect to the CGRA.

### First Modification

In the first embodiment, the mapping result verification apparatus 1 verifies the validity by using the output value received from each of the PEs 100, but the information that is used for the verification is not limited to this. For example, it is possible to verify the validity by using an input value that is input to each of the PEs 100.

In this case, the verification information generation unit 12 registers, in the verification information list 130, information on an input performed at each of the cycles as the verification information. For example, the verification information generation unit 12 registers information, such as <(location of PE), <{input port ID, output value}>, in the verification information list 130.

The verification unit 13 performs verification on the input performed with respect to each of the PEs 100. For example, the verification unit 13 checks, by using the verification information list 130, whether the output values that are used for the arithmetic operation by the PE 100 are matched with all of the values that are input to the subject PE 100, and also, checks that the arithmetic operation designated in the DFG 31 is performed in the PE 100. As a result of these items being checked, the verification unit 13 is able to check that the mapping obtained at the subject cycle is valid.

Here, in a case where an input is used, the verification information generation unit 12 uses the connection relationship indicated in the CGRA at the time of verification of the input value that is in the verification information list 130, so that the verification unit 13 does not need to determine the value that is input to the port provided in each of the PEs 100 on the basis of the connection relationship indicated in the CGRA. However, in a case where an output value is output from the same output port to a plurality of ports, the number of elements each having the same value increases.

As described above, even in a case where an input is used, the mapping result verification apparatus 1 is able to appropriately verify the mapping result. Therefore, it is possible to improve the accuracy of the mapping with respect to the CGRA.

### Second Modification

Furthermore, in the first embodiment, the mapping result verification apparatus 1 verifies the mapping validity obtained from the calculation performed once, but the target for the verification may be a process performed by pipeline execution. For example, even in a case where processes performed between a process of inputting the output value received from an input node and a process of outputting a calculation result are continuously and repeatedly performed by the pipeline execution, it is also possible to verify the validity of the mapping result.

In this case, when the verification information generation unit 12 registers the output value received from the input node in the verification information list 130, the verification information generation unit 12 sequentially assigns sequential numbers starting from one, and assigns information indicating how many output values are present in the verification information list 130 before the subject output value. As a result of this, it is possible to distinguish whether the subject output value received from the input node is the information that is to be used in which of the pipeline process from among the pipeline processes to be performed.

In also this case, similarly to the first embodiment, the verification unit 13 performs verification of the validity of the mapping result by using the verification information, the architecture of the CGRA, and the information indicated in the DFG. Furthermore, the verification unit 13 repeats the verification on the output value received from the input node by the number of times corresponding to the number of pipeline processes. When the number that has been assigned to the output value received from the input node reaches the number of pipeline processes, the verification unit 13 ends the verification of the mapping result at the time of the end of the verification performed at that stage.

As described above, the mapping result verification apparatus 1 is also able to check the validity of the mapping result obtained from the pipeline process by using an abstract value. Therefore, also regarding to pipeline process, it is also possible to improve the accuracy of the mapping with respect to the CGRA.

### (b) Second Embodiment

In the following, a second embodiment will be described. For example, a description will be given by using a case in which a deep neural network is implemented by the CGRA as an example. There may be a case in which activating function of the DNN is implemented by a composite function of an elementary function, such as exponential, sin, cos, and errfn. In this case, the automatic mapper 2 is able to perform the mapping at high speed by performing overall mapping by using a combination of individual mapping results of the portion corresponding to the elementary function, instead of performing mapping of the entirety of the DFG. In this way, in the mapping performed on the basis of the combination of the mapping results or in the mapping performing by replacing a part of the result, the mapping result verification apparatus 1 is able to perform verification by representing a specific portion, such as a portion corresponding to the elementary function, in a library manner.

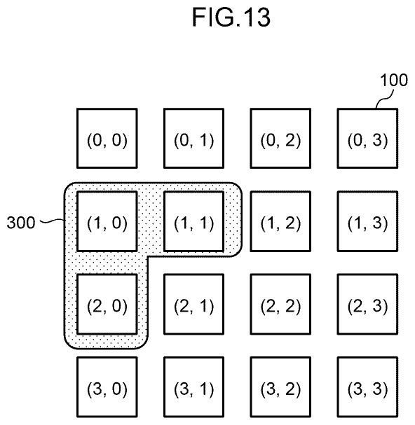

FIG. 13 is a diagram illustrating one example of the mapping indicated by using a combination of the mapping and an already existing mapping result in some portion. Here, the CGRA has a structure in which the PEs 100 are arranged in a 4×4 array. Then, in the process of mapping into the CGRA illustrated in FIG. 13, a component 300 in which the mapping result has been verified and the validity has been guaranteed are used.

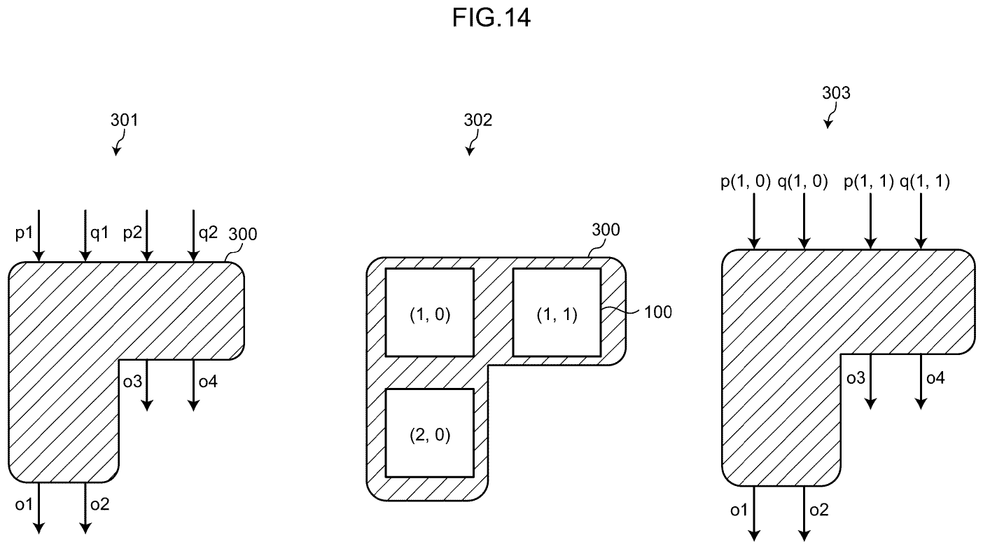

FIG. 14 is a diagram for explaining extension of the representation method of representing the mapping. In the following, the extension of the representation method of representing the mapping related to the component 300 performed by the automatic mapper 2 will be described. For example, as illustrated in an input/output state 301, the component 300 includes p1, q1, p2, and q2 as the input ports, and includes o1, o2, o3, and o4 as the output ports. Furthermore, if the port name of each of the input ports is set as an input value, and the port name of each of the outputs port is set as an output value, the relationships can be expressed by o1=p1, o2=f (p1, p2), o3=p2, and o4=q2.

Then, as illustrated in a mapping result 302, the component 300 is mapped to the PEs 100 located at (1, 0), (1, 1), and (2, 0). Here, each of the PEs 100 includes p and q as the input ports.

In a case where the mapping has been performed as indicated by the mapping result 302, as illustrated by an input/output 303, the input p1 of the component 300 corresponds to the input port denoted by p that is provided in the PE 100 located at (1, 0). Here, the input value to the input port denoted by p that is provided in the PE 100 located at (1, 0) is denoted by p (1, 0). Furthermore, the input q1 corresponds to an input to the input port denoted by q that is provided in the PE 100 located at (1, 0). Here, the input value to the input port denoted by q that is provided in the PE 100 located at (1, 0) is denoted by q (1, 0). Furthermore, the input p2 corresponds to an input to the input port denoted by p that is provided in the PE 100 located at (1, 1). Here, the input value to the input port denoted by p that is provided in the PE 100 located at (1, 1) is denoted by p (1, 1). Furthermore, the input q2 corresponds to an input to the input port denoted by q that is provided in the PE 100 located at (1, 1). Here, the input value to the input port denoted by q that is provided in the PE 100 located at (1, 1) is denoted by q (1, 1).

In other words, o1=p (1, 0) holds, and also, o1 is output at two cycles after the input to the component 300. Furthermore, o2=f (p (1, 0), p (1, 1)) holds, and also, o2 is output at two cycles after the input to the component 300. Furthermore, o3=p (1, 1) holds, and also, o3 is output at two cycles after the input to the component 300. Furthermore, o4=q (1, 1) holds, and also, o4 is output at two cycles after the input to the component 300.

The verification performed on the mapping result obtained from the mapping using the above described representation method for representing the mapping will be described. The mapping result verification apparatus 1 according to the present embodiment is also indicated by the block diagram illustrated in FIG. 1. In the description below, the same operation of each of the units as that described in the first embodiment will be omitted.

Here, the already existing mapping result in the mapping result of the mapping performed in combination with the already existing mapping result corresponds to one example of “a predetermined mapping result of the mapping that performs a predetermined arithmetic operation including one or the plurality of arithmetic operations”. In other words, the information collection unit 11 acquires the mapping result of the mapping that has been performed by using the predetermined mapping result of the mapping that performs the predetermined arithmetic operation including one or the plurality of arithmetic operations.

The verification information generation unit 12 receives an input of each of the DFG and the mapping result from the information collection unit 11. In the following, the verification information generation unit 12 assumes that the timing of the output from the input node is the zero cycle, and regards the output value received from the virtual PE 100 corresponding to the input node as the output value at the zeroth cycle. Then, the verification information generation unit 12 outputs the generated output value to the verification unit 13.

In a case where the input value is output by the PE 100 without any change, the verification information generation unit 12 regards the input value as the output value. Furthermore, in a case where the arithmetic operation result becomes an output value, the verification information generation unit 12 regards the identification information on the PE 100 that outputs the arithmetic operation result as an output value.

After that, when the verification information generation unit 12 sequentially receives, for each cycle from the first cycle, a notification of the verified validity verification unit 13, the verification information generation unit 12 generates an output value that is to be output from each of the PEs 100 at the subsequent cycle. Then, the verification information generation unit 12 outputs the generated output value to the verification unit 13.

The verification unit 13 receives an input of the output value that has been output at the zeroth cycle. Then, the verification unit 13 performs the first verification and the second verification related to the PE 100 in which the output value is input at the first cycle. In a case where the validity of the mapping result at the subject cycle has been checked on the basis of the first verification and the second verification, the verification unit 13 outputs a notification of the verified validity to the verification information generation unit 12.

After that, when the verification unit 13 receives an input of the verification information from the verification information generation unit 12, the verification unit 13 sets the cycle having the smallest number of cycles after the cycle at which the validity verification has already been finished included in the acquired verification information as a target for the verification. Then, the verification unit 13 performs the first verification and the second verification on the PE 100 in which the output value is input at the cycle targeted for the verification. In a case where the validity of the mapping result at the subject cycle has been checked on the basis of the first verification and the second verification, the verification unit 13 outputs a notification of the verified validity to the verification information generation unit 12. Furthermore, in a case where the subsequent PE 100 in which the output value is to be input is not present, the verification unit 13 sets the subject output value as one of the outputs of the calculation results obtained by the CGRA.

Then, if the PE 100 that operates for all of the output values at the subsequent cycle is not present any more, the verification unit 13 correctively outputs the output values as the outputs of the calculation results obtained by the CGRA to the output count checking unit 14 together with the DFG. In this way, the verification unit 13 verifies whether or not the mapping results match the mapping results indicated in the data flow graph by using the arithmetic operation result that is obtained by performing the predetermined arithmetic operation by using the symbols related to the predetermined mapping result.

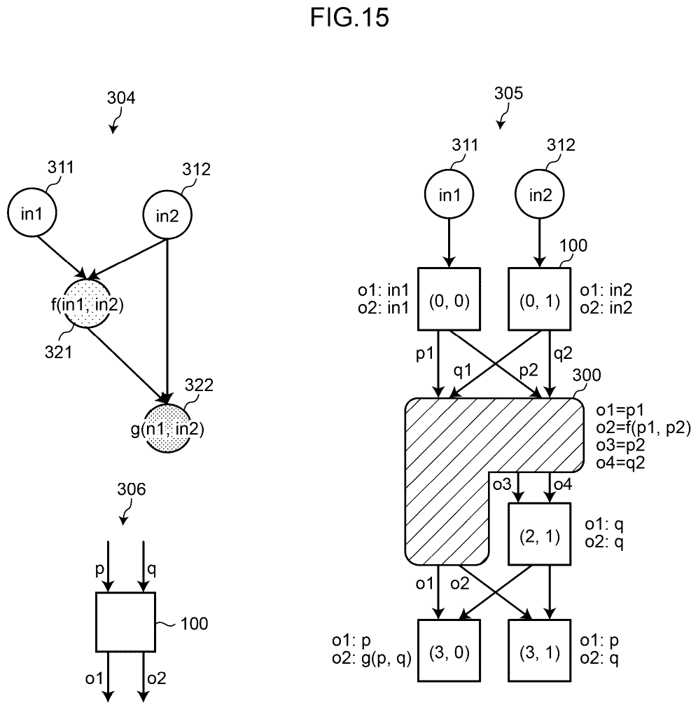

FIG. 15 is a diagram illustrating one example of the mapping result according to the second embodiment. Here, a description will be given in a case in which the DFG that includes a DFG 304 illustrated in FIG. 15 in a part of the area in the DFG is mapped in the CGRA and a mapping result that includes a mapping result 305 in a part of the area in the mapping result is obtained.

The DFG 304 includes nodes 311 and 312 and nodes 321 and 322 that are the input nodes. The node 311 performs an input to the CGRA by using in1 as an output value. Furthermore, the node 312 performs an input to the CGRA by using in2 as an output value. The node 321 performs an arithmetic operation represented by the function indicated by f (in1, in2). The arithmetic operation result obtained by the node 321 is an output value that is output to the node 322. The node 322 performs an arithmetic operation represented by the function indicated by g (n1, in2).

In the mapping result 305, the node 321 included in the DFG 304 is mapped as the component 300. Furthermore, the node 322 included in the DFG 304 is mapped into the PE 100 located at (3, 0). Here, as illustrated in an input/output state 306, the PE 100 includes two input ports denoted by p and q. Furthermore, the PE 100 includes two output ports denoted by o1 and o2. Furthermore, the component 300 includes the input port and the output port indicated by the input/output state 301 illustrated in FIG. 14. In addition, in the mapping result 305 illustrated in FIG. 14, the output value that is output from each of the output ports with respect to the value that has been input is illustrated in the vicinity of each of the PE 100 and the component 300. Here, the value that has been input is denoted by the name of the port that receives the input.

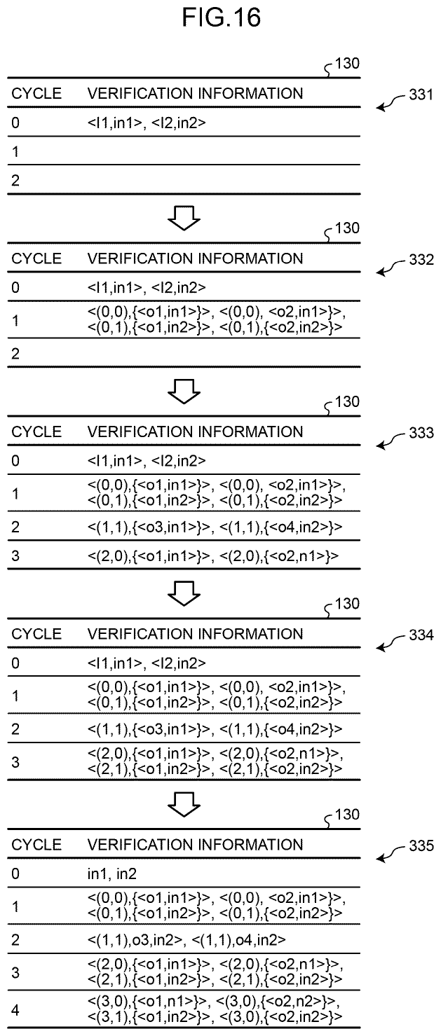

The mapping result verification process according to the second embodiment will be described on the basis of the above description. FIG. 16 is a diagram illustrating transitions of the verification information lists obtained in the mapping verification process according to the second embodiment. Here, the identification information on the node 311 is denoted by I1, and the identification information on the node 312 is denoted by I2.

An output of in1 is output from the node 311 as the output value at the zeroth cycle, and an output of in2 is output as the output value from the node 312. Accordingly, as indicated by a state 331 illustrated in FIG. 16, the verification information generation unit 12 registers the verification information indicating a combination of I1 and I2 that are the identification information on the nodes 311 and 312, respectively, and in1 and in2 that are the output values output from the nodes 311 and 312, respectively, in the verification information list 130. Then, the verification information generation unit 12 outputs the verification information list 130 in which the registration has been completed to the verification unit 13.

The verification unit 13 checks the verification information list 130. Then, the verification unit 13 performs verification on the PE 100 that is located at (0, 0) and that uses the output value that is output at the zeroth cycle. An input to the PE 100 located at (0, 0) is an output of the input node having the identification information denoted by I1, and the verification unit 13 checks that the output of the input node having the identification information denoted by I1 is present at the zeroth cycle indicated in the verification information list 130.

In the following, the verification unit 13 checks that the output value that is used at the node that is allocated to the PE 100 located at (0, 0) in the DFG 304 is in1. Furthermore, the verification unit 13 checks, on the basis of the connection information on the CGRA, that the output value with respect to the input port that is denoted by p and that is provided in the PE 100 located at (0, 0) is the output value from the input node having the identification information denoted by I1. Then, the verification unit 13 checks that the output value of the input node having the identification information denoted by I1 is in1. Accordingly, the verification unit 13 is able to check that the values of the signal obtained at the zeroth cycle are fully matched with the values of the signal output from the PE 100 corresponding to the input source in the DFG 304. Furthermore, the verification unit 13 is able to check that the arithmetic operation is not allocated to the PE 100 located at (0, 0) and the value that has been input is able to be allowed to pass.

The verification unit 13 is also perform the same verification on the PE 100 that is located at (0, 1) and that uses the output value output at the zeroth cycle. When the verification on both of the PEs 100 has been successful, the verification unit 13 outputs a notification of the verified validity to the verification information generation unit 12.

In the following, at the first cycle, each of the PE 100 located at (0, 0) and the PE 100 located at (0, 1) passes the input value. Accordingly, as indicated by a state 332, the verification information generation unit 12 registers the verification information that corresponds to a combination of (0, 0) that is the identification information on the PE 100 located at (0, 0) and in1 that is the output value from the output ports denoted by o1 and o2 in the verification information list 130. Furthermore, the verification information generation unit 12 registers the verification information that corresponds to a combination of (0, 1) that is the identification information on the PE 100 located at (0, 1) and in1 that is the output value from the output ports denoted by o1 and o2 in the verification information list 130. Then, the verification information generation unit 12 outputs the verification information list 130 in which the registration has been completed to the verification unit 13.

The verification unit 13 checks the verification information list 130. Then, the verification unit 13 sets the first cycle that is the smallest number of registered cycles after the zeroth cycle in which the verification has already been finished and that is stored in the verification information list 130 as a target for the verification.

The verification unit 13 performs verification on the component 300 that uses the output value that has been output at the first cycle. An input to the component 300 is an output from each of the PE 100 located at (0, 0) and the PE 100 located at (0, 1), and the verification unit 13 checks that each of the pieces of identification information is present in the first cycle stored in the verification information list 130.

In the following, the verification unit 13 checks that the output values to be used by the node that is allocated to the component 300 in the DFG 304 are in1 and in2. Furthermore, the verification unit 13 checks, on the basis of the connection information on the CGRA, that the output value with respect to the input port that is denoted by p1 and that is provided in the component 300 is the output value from the output port that is denoted by o1 and that is provided in the PE 100 having the identification information of (0, 0). Then, the verification unit 13 checks that the output value from the output port that is denoted by o1 and that is provided in the PE 100 located at (0, 0) is in1. Furthermore, the verification unit 13 checks, on the basis of the connection information on the CGRA, that the output value with respect to the input port that is denoted by q1 and that is provided in the component 300 is the output value from the output port that is denoted by o1 and that is provided in the PE 100 having the identification information of (0, 1). Then, the verification unit 13 checks that the output value from the output port that is denoted by o1 and that is provided in the PE 100 located at (0, 1) is in2. Furthermore, the verification unit 13 checks, on the basis of the connection information on the CGRA, that the output value with respect to the input port that is denoted by p2 and that is included in the component 300 is the output value from the output port that is denoted by o2 and that is provided in the PE 100 having the identification information of (0, 0). Then, the verification unit 13 checks that the output value from the output port that is denoted by o2 and that is provided in the PE 100 located at (0, 0) is in1. Furthermore, the verification unit 13 checks, on the basis of the connection information on the CGRA, that the output value with respect to the input port that is denoted by q2 and that is provided in the component 300 is the output value from the output port that is denoted by o2 and that is provided in the PE 100 having the identification information of (0, 1). Then, the verification unit 13 checks that the output value from the output port that is denoted by o2 and that is provided in the PE 100 located at (0, 1) is in2. Accordingly, the verification unit 13 is able to check that all of the values that are output from the signal and that are obtained at the first cycle are fully matched with the values of the signal output from the PE 100 that is the input source in the DFG 304.

Furthermore, the verification unit 13 checks that the arithmetic operation performed by the component 300 matches f (in1, in2) the arithmetic operation that is performed by the node 321 included in the DFG 304. After that, the verification unit 13 outputs a notification of the verified validity to the verification information generation unit 12.

Then, the verification information generation unit 12 generates the verification information related to the output from the component 300. The component 300 outputs in1 from the output port denoted by o3 and outputs in2 from the output port denoted by o4 at the second cycle. Furthermore, the component 300 outputs in1 from the output port denoted by o3 and outputs in2 from the output port denoted by o4 at the third cycle. The verification information generation unit 12 has in advance the number of cycles needed for a period of time between an input performed into the component 300 and an output from the output port that is provided in each of the components 300, so that the verification information generation unit 12 is able to check which output port provided in the component 300 is used for the output at each of the cycles.

The verification information generation unit 12 specifies that the PE 100 that performs an output from the component 300 at the second cycle is the PE 100 located at (1, 1). Then, As indicated by a state 333, the verification information generation unit 12 registers the verification information that corresponds to a combination of (1, 1) that is the identification information on the PE 100 located at (1, 1) and in1 that is the output value from the output port that is denoted by o3 and that is provided in the component 300 in the second cycle that is included in the verification information list 130. Furthermore, the verification information generation unit 12 registers the verification information that corresponds to a combination of (1, 1) that is the identification information on the PE 100 located at (1, 1) and in2 that is the output value from the output port that is denoted by o4 and that is provided in the component 300 in the second cycle that is included in the verification information list 130.

Furthermore, the verification information generation unit 12 specifies that the PE 100 that performs an output from the component 300 at the third cycle is the PE 100 located at (2, 0). Then, as indicated by the state 333, the verification information generation unit 12 registers the verification information that corresponds to a combination of (2, 0) that is the identification information on the PE 100 located at (2, 0) and in1 that is the output value from the output port that is denoted by o1 and that is included in the component 300 in the third cycle that is included in the verification information list 130. Furthermore, the verification information generation unit 12 identifies that the output value from the output port that is denoted by o2 and that is included in the component 300 is the arithmetic operation result, so that the verification information generation unit 12 sets the subject output value as the identification information on the component 300. Here, the verification information generation unit 12 sets the identification information on the component 300 to n1. Accordingly, the verification information generation unit 12 registers the verification information that corresponds to a combination of (2, 0) that is the identification information on the PE 100 located at (2, 0) and n1 that is the output value from the output port that is denoted by o2 and that is provided in the component 300 in the third cycle that is included in the verification information list 130. Then, the verification information generation unit 12 outputs the verification information list 130 in which the registration has been completed to the verification unit 13.

The verification unit 13 checks the verification information list 130. Then, the verification unit 13 sets the second cycle that is the smallest number of registered cycles after the first cycle in which the verification has already been finished and that is stored in the verification information list 130 as a target for the verification.

The verification unit 13 performs verification on the PE 100 that is located at (2, 1) and that uses the output value that has been output at the second cycle. An input to the PE 100 located at (2, 1) is an output from the PE 100 located at (1, 1) included in the component 300, and the verification unit 13 checks that the identification information on the PE 100 located at (1, 1) is present in the first cycle that is included in the verification information list 130.

Then, the verification unit 13 checks that the node that has been allocated to the PE 100 located at (2, 1) included in the DFG 304 is not present, checks that the PE 100 located at (2, 1) is the node that passes the value that has been input, and checks that the output value to be passed is in1 and in2. Furthermore, the verification unit 13 checks, on the basis of the connection information on the CGRA, that the value that is input to the PE 100 located at (2, 1) is the output value output from the output ports that are denoted by o3 and o4 and that are provided in the component 300. Then, the verification unit 13 checks that the output value output from the output port that is denoted by o3 and that is included in the component 300 is in1. Furthermore, the verification unit 13 checks that the output value output from the output port that is denoted by o4 and that is included in the component 300 is in2. Accordingly, the verification unit 13 is able to check that all of the values that are output from the signal and that are obtained at the second cycle are fully matched with the values of the signal output from the PE 100 that is the input source in the DFG 304. Furthermore, the verification unit 13 is able to check that the value that has been input is allowed to pass because the arithmetic operation is not allocated to the PE 100 located at (2, 1). After that, the verification unit 13 outputs a notification of the verified validity to the verification information generation unit 12.

After that, the verification information generation unit 12 generates the verification information related to an output from the PE 100 located at (2, 1). The PE 100 located at (2, 1) outputs in1 from the output port denoted by o1, and outputs in2 from the output port denoted by o2 at the third cycle. Accordingly, as indicated by a state 334, the verification information generation unit 12 registers the verification information that corresponds to a combination of (2, 1) that is the identification information on the PE 100 located at (2, 1) and in2 that is the output value from the output port that is denoted by o1 and that is provided in the PE 100 located at (2, 1) in the third cycle that is included in the verification information list 130. Furthermore, the verification information generation unit 12 registers the verification information that corresponds to a combination of (2, 1) that is the identification information on the PE 100 located at (2, 1) and in2 that is the output value from the output port that is denoted by o2 and that is provided in the PE 100 located at (2, 1) in the third cycle that is included in the verification information list 130.

The verification unit 13 checks the verification information list 130. Then, the verification unit 13 sets the third cycle that is the smallest number of registered cycles after the second cycle in which the verification has already been finished and that is stored in the verification information list 130 as a target for the verification.

The verification unit 13 performs verification on the PE 100 that is located at (3, 0) and that uses the output value that has been output at the third cycle. An input to the PE 100 located at (3, 0) is an output from the PE 100 located at (2, 1) and an output from the PE 100 located at (2, 0) included in the component 300, and the verification unit 13 checks that the pieces of identification information on the PE 100 located at (2, 0) and the PE 100 located at (2, 1) are present in the third cycle that is included in the verification information list 130.

Then, the verification unit 13 checks that the output value that is used by the node that is allocated to the PE 100 located at (3, 0) in the DFG 304 is n1 and in2. Furthermore, the verification unit 13 checks, on the basis of the connection information on the CGRA, that the value that is input to the PE 100 located at (3, 0) is the output value output from the output port that is denoted by o1 and that is included in the component 300 and is the output value from the output port that is denoted by o1 and that is provided in the PE 100 located at (2, 1). Then, the verification unit 13 checks that the output value output from the output port that is denoted by o1 and that is included in the component 300 is n1. Furthermore, the verification unit 13 checks that the output value that is denoted by o1 and that is provided in the PE 100 located at (2, 1) is in2. Accordingly, the verification unit 13 is able to check that all of the values that are output from the signal and that are obtained at the second cycle are fully matched with the values of the signal output from the PE 100 that is the input source in the DFG 304. Furthermore, the verification unit 13 checks that the arithmetic operation that has been allocated to the PE 100 located at (3, 0) matches g (n1, in2) that is the arithmetic operation that is performed by the node 322 included in the DFG 304.

The verification unit 13 is also perform the same verification on the PE 100 that is located at (3, 1) and that uses the output value output at the third cycle. When the verification on both of the PEs 100 has been successful, the verification unit 13 outputs a notification of the verified validity to the verification information generation unit 12.

After that, the verification information generation unit 12 generates the verification information that is related to an output to be performed at the fourth cycle, and registers, as indicated in a state 335, the generated verification information in the verification information list 130. After that, the verification unit 13 and the verification information generation unit 12 repeat the verification until the PE 100 that uses the output value is not present any more.

As described above, the mapping result verification apparatus 1 according to the present embodiment is able to perform verification on the mapping result of the mapping performed in combination of the already existing mapping results, and is able to determine the validity of the obtained mapping result. In this way, regarding the mapping result in which a part of validity has been guaranteed and there is no need to perform the verification on the validity of this part, the mapping result verification apparatus 1 is able to check that the mapping result also indicates the same data flow indicated in the DFG by using the symbolic execution to perform the arithmetic operation. Therefore, in this case, also, the mapping result verification apparatus 1 is able to perform the verification that is similar to the comprehensive verification at low cost by performing the arithmetic operation by using abstract values, which makes it possible to improve the accuracy of the mapping with respect to the CGRA.

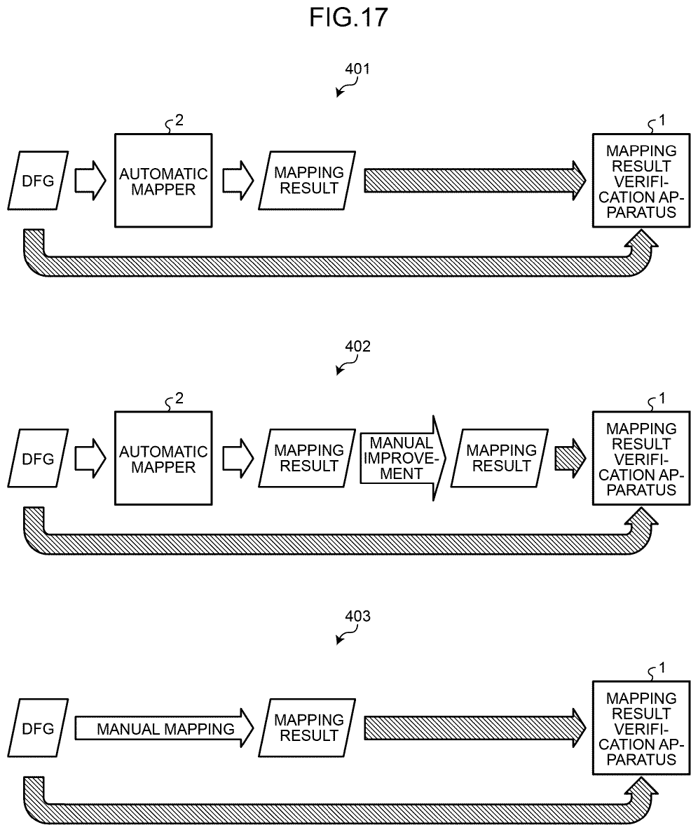

FIG. 17 is a diagram illustrating one example of a method for utilization of the mapping result verification apparatus. In the following, the method for utilization of the mapping result verification apparatus 1 that has been described above in each of the embodiments and the modification will be described with reference to FIG. 17.

A configuration 401 indicates the method for utilization of the mapping result verification apparatus 1 in a case where the automatic mapper 2 is currently under development. For example, in a case where the automatic mapper 2 is currently under development, the mapping result verification apparatus 1 causes the automatic mapper 2 to generate the mapping result with respect to a predetermined DFG. Then, the mapping result verification apparatus 1 verifies the validity of the mapping result by using both of the predetermined DFG and the mapping result. In a case where the mapping result is not correct, the mapping result verification apparatus 1 is able to correct the algorithm for the automatic mapper 2 by providing feedback about the verification result to the development of the automatic mapper 2.

A configuration 402 indicates the method for utilization of the mapping result verification apparatus 1 in a case where the mapping result that has been generated by the automatic mapper 2 is manually improved. For example, a mapping result that has manually been improved is generated as a result of a user making some alterations on the mapping result that has been generated, on the basis of the predetermined DFG, by the automatic mapper 2 in which the validity of the already existing mapping result has already been checked. Then, the mapping result verification apparatus 1 verifies the validity of the mapping result that has manually been improved by using the predetermined DFG and the mapping result that has manually been improved. In a case where the mapping result is not correct, the user is able to manually correct the improvement of the verification result.

A configuration 403 indicates the method for utilization of the mapping result verification apparatus 1 with respect to the manually mapping. For example, it is conceivable that the user manually performs mapping on the basis of the predetermined DFG without using the automatic mapper 2 and a mapping result is accordingly generated. In this case, the mapping result verification apparatus 1 is also able to verify the validity of the mapping result of the manual mapping by using the predetermined DFG and the mapping result obtained from the manual mapping. In a case where the mapping result is not correct, the user is able to add a correction to the manual mapping on the basis of the verification result.

### Hardware Configuration)

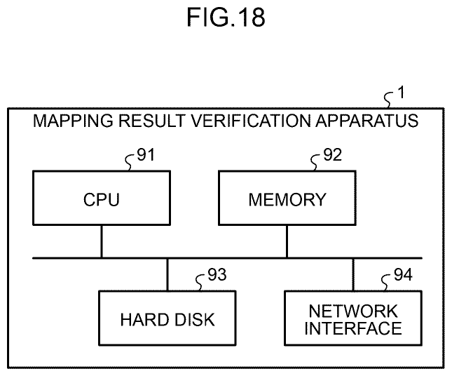

FIG. 18 is a diagram illustrating a hardware configuration of the mapping result verification apparatus. In the following, one example of the hardware configuration for implementing each of the functions of the mapping result verification apparatus 1 will be described with reference to FIG. 18.

As illustrated in FIG. 18, the mapping result verification apparatus 1 includes, for example, a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the mapping result verification apparatus 1 and an external device. The network interface 94 relays communication between, for example, the automatic mapper 2 and the CPU 91, and between, for example, the user terminal device 3 and the CPU 91. For example, the network interface 94 is used for communication in the information collection unit 11 and the output unit 15 with the external device.

The hard disk 93 is an auxiliary storage device. The hard disk 93 stores therein various kinds programs including the programs for implementing the functions of the information collection unit 11, the verification information generation unit 12, the verification unit 13, the output count checking unit 14, and the output unit 15 illustrated in FIG. 1 as an example.

The memory 92 is a main storage device. For example, a dynamic random access memory (DRAM) may be used for the memory 92.

The CPU 91 reads out the various kinds of programs from the hard disk 93, loads the read programs into the memory 92, and executes the programs. As a result of this, the CPU 91 implements the function of the information collection unit 11, the verification information generation unit 12, the verification unit 13, the output count checking unit 14, and the output unit 15 illustrated in FIG. 1 as an example.

Furthermore, in the present embodiment, the mapping result verification apparatus 1 is constituted by a device that is different from the automatic mapper 2 and the user terminal device 3, but the embodiment is not limited to this. It is possible to embed the function of the mapping result verification apparatus 1 into the automatic mapper 2 or the user terminal device 3.

According to an aspect of one embodiment, the present invention is able to improve the accuracy of mapping with respect to the CGRA.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a mapping result verification program that causes a computer to execute a process comprising:
acquiring both of a data flow graph that represents predetermined calculation including a plurality of arithmetic operations and a mapping result obtained by mapping the data flow graph into a CGRA that includes a plurality of arithmetic operation units; and
verifying, regarding each of first arithmetic operation units to which the arithmetic operations have been respectively allocated in the mapping result, based on an arithmetic operation result that has been obtained by performing the arithmetic operations, whether or not the mapping result matches the data flow graph.

2. The non-transitory computer-readable recording medium according to claim 1, wherein the process further includes generating verification information that includes information on an output value of each of the arithmetic operation units used in the mapping result, wherein
the verifying includes comparing the verification information with the information on the output values of the respective arithmetic operations in the data flow graph.

3. The non-transitory computer-readable recording medium according to claim 1, wherein
the acquiring includes acquiring the mapping result in which information that is output from the first arithmetic operation units and that includes the arithmetic operation result is used as information that is input to another arithmetic operation unit or as a calculation result of the predetermined calculation, and
the verifying includes verifying whether or not the mapping result matches the data flow graph by comparing information corresponding to an input of the arithmetic operation allocated to each of the first arithmetic operation units in the data flow graph with information that is input to each of the first arithmetic operation units in the mapping result.

4. The non-transitory computer-readable recording medium according to claim 3, wherein the verifying includes comparing, based on information that indicates a connection relationship between the arithmetic operation units, the information corresponding to the input of the arithmetic operation allocated to each of the first arithmetic operation units in the data flow graph with the information that is input to each of the first arithmetic operation units in the mapping result.

5. The non-transitory computer-readable recording medium according to claim 3, wherein the verifying includes comparing the output node specified in the data flow graph with the output from the mapping result.

6. The non-transitory computer-readable recording medium according to claim 1, wherein
the acquiring includes acquiring the mapping result of the mapping performed by using a predetermined mapping result of the mapping that performs a predetermined arithmetic operation including one or the plurality of arithmetic operations, and
the verifying includes verifying, regarding the predetermined mapping result, whether or not the mapping result matches the data flow graph by using the arithmetic operation result that has been obtained by performing the predetermined arithmetic operation by using a symbol.

7. A mapping result verification method comprising:
acquiring both of a data flow graph that represents predetermined calculation including a plurality of arithmetic operations and a mapping result obtained by mapping the data flow graph into a CGRA that includes a plurality of arithmetic operation units; and
verifying, regarding each of first arithmetic operation units to which the arithmetic operations have been respectively allocated in the mapping result, based on an arithmetic operation result that has been obtained by performing the arithmetic operations, whether or not the mapping result matches the data flow graph, using a processor.

8. A mapping result verification apparatus comprising:
a processor configured to:
acquire both of a data flow graph that represents predetermined calculation including a plurality of arithmetic operations and a mapping result obtained by mapping the data flow graph into a CGRA that includes a plurality of arithmetic operation units; and
verify, regarding each of first arithmetic operation units to which the arithmetic operations have been respectively allocated in the mapping result, based on an arithmetic operation result that has been obtained by performing the arithmetic operations, whether or not the mapping result matches the data flow graph.
